(19) United States
(12) Patent Application Publication
(10) Pub. No.: US 2016/0314288 A1
(43) Pub. Date: Oct. 27, 2016

(54) METHOD AND APPARATUS FOR WRITE RESTRICTED STORAGE

(71) Applicant: QUALCOMM Incorporated, San Diego, CA (US)

(72) Inventor: Or Elnekaveh, Kfar Vitkin (IL)

(21) Appl. No.: 14/693,558

(22) Filed: Apr. 22, 2015

(51) Int. Cl. G06F 21/30

(52) U.S. Cl. CPC G06F 21/30

(57) ABSTRACT

Disclosed is a method for write restricted storage. In the method, a controller maintains an authorization list received over a control path. The authorization list includes at least one authorized data block digest, and each authorized data block digest is based on a corresponding authorized data block. The controller generates a calculated digest for a data block received over a data path. The controller determines if the calculated digest for the data block matches an authorized data block digest in the authorization list. The controller writes the data block to a storage if the calculated digest matches the authorized data block digest in the authorization list.

### BACKGROUND

1. Field

The present invention relates generally to restricting writes to storage to pre-approved data.

2. Background

The firmware of most computing devices generally resides on modifiable non-volatile (NV) memory, such as flash storage. A firmware over the air update (FOTA) may be used to update the firmware of a mobile computing device. However, a FOTA is a sensitive and a complex process, consisting of multiple steps in multiple components, often not by the same vendor and not necessarily in the same execution environment context, where the order of execution may be unknown at the start of the process, and/or errors may be unpredictable. As an example, the flash storage of a mobile computing device may have write protection. Write protection offers solid protection against unauthorized modification or tampering, but when the storage legitimately needs to be modified, it is necessary to remove the write protection, and more importantly, reinstate it once the modification is complete. In the context of a FOTA, securely removing and reinstating write protection has non-trivial implementation issues because it may be difficult to securely implement partly due to unknown control paths taken in the process.

Traditional write protection schemes provide one method to remove write protection, and another method to reinstate the write protection. However, when the protection is off (the storage is unlocked, i.e., writing is permitted), anything can be written, including malicious code. Also, when the protection is on (the storage is locked), nothing can be written, not even legitimate code.

There is therefore a need for a technique for efficiently and securely modifying the storage of a computing device.

### SUMMARY

An aspect of the invention may reside in a method for write restricted storage. In the method, a controller maintains an authorization list received over a control path. The authorization list includes at least one authorized data block digest, and each authorized data block digest is based on a corresponding authorized data block. The controller generates a calculated digest for a data block received over a data path. The controller determines if the calculated digest for the data block matches an authorized data block digest in the authorization list. The controller writes the data block to a storage if the calculated digest matches the authorized data block digest in the authorization list.

In more detailed aspects of the invention, the controller may authenticate the authorization list. The control path may be a secure control path, and the data path may not be as secure as the secure control path. Each authorized data block digest may be generated from the corresponding authorized data block using a hash function.

Another aspect of the invention may reside in an apparatus, comprising: means for maintaining an authorization list received over a control path, wherein the authorization list includes at least one authorized data block digest, and each authorized data block digest is based on a corresponding authorized data block; means for generating a calculated digest for a data block received over a data path; means for determining if the calculated digest for the data block matches an authorized data block digest in the authorization list; and means for writing the data block to a storage if the calculated digest matches the authorized data block digest in the authorization list.

Another aspect of the invention may reside in an apparatus, comprising: a storage for storing authorized data blocks received over a data path; and a controller configured to control writes of data blocks to the storage based on an authorization list, received over a control path, of authorized data block digests, wherein each authorized data block digest is based on a corresponding authorized data block; the controller further configured to generate a calculated digest for a data block received over the data path, allow writing the data block to the storage if the calculated digest matches an authorized data block digest in the authorization list, and prohibit writing of the data block to the storage if the calculated digest does not match an authorized data block digest in the authorization list.

Another aspect of the invention may reside in a computer-readable medium, comprising: code for causing a computer to maintain an authorization list received over a control path, wherein the authorization list includes at least one authorized data block digest, and each authorized data block digest is based on a corresponding authorized data block; code for causing the computer to generate a calculated digest for a data block received over a data path; code for causing the computer to determine if the calculated digest for the data block matches an authorized data block digest in the authorization list; and code for causing a computer to write the data block to a storage if the calculated digest matches the authorized data block digest in the authorization list.

### BRIEF DESCRIPTION OF THE DRAWINGS

FIG. 1 is a flow diagram of a method for write restricted storage, according to the present invention.

FIG. 2 is a block diagram an integrated circuit having write restricted storage.

FIG. 3 is a schematic diagram of a data structure related to data blocks and a list of associated hash values, for comparison with calculated hash values of received data blocks.

FIG. 4 is a flow diagram of another method for write restricted storage, according to the present invention.

FIG. 5 is a block diagram of a computer including a memory and a processor.

FIG. 6 is a block diagram of an example of a wireless communication system.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

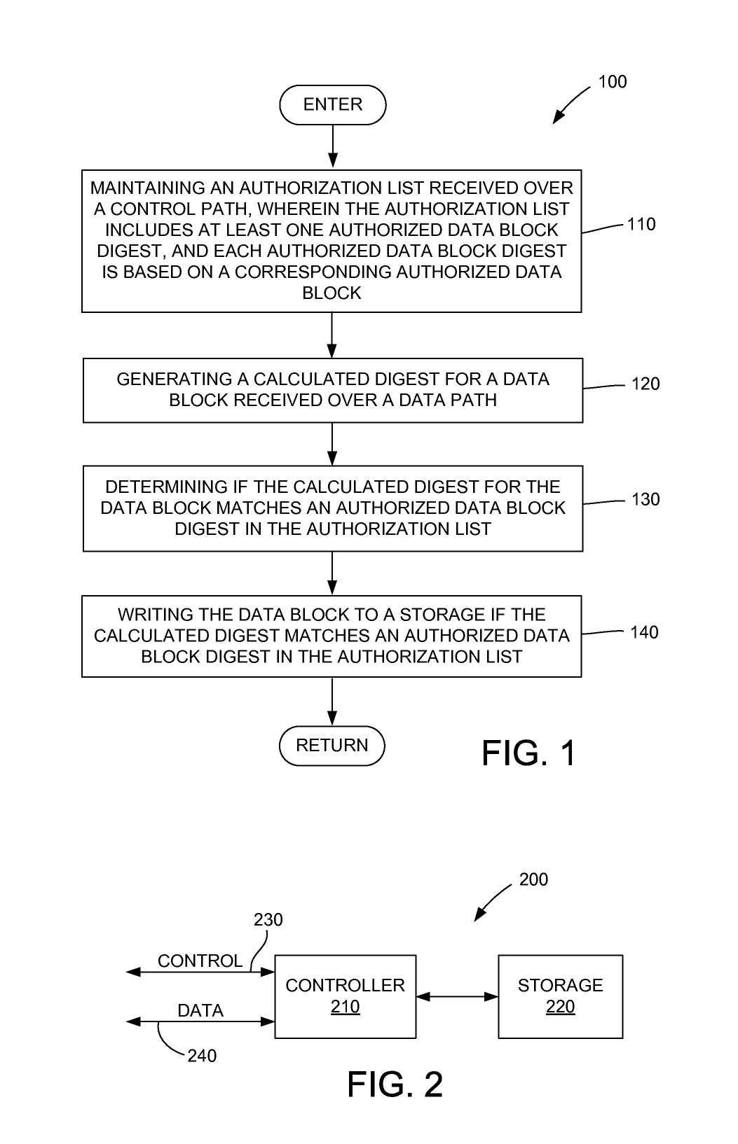

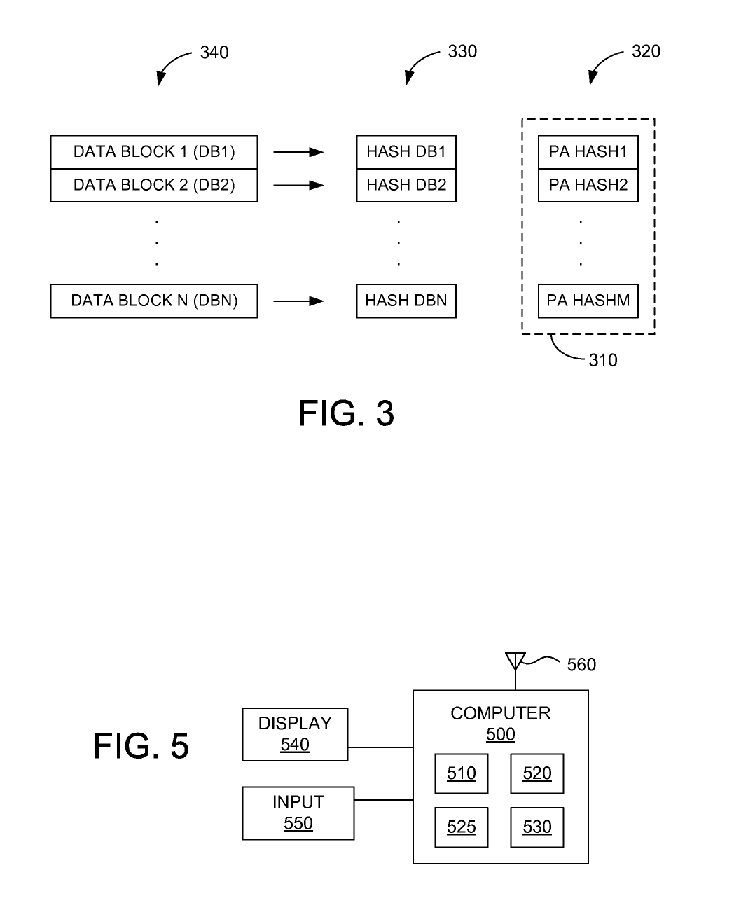

With reference to FIGS. 1-3, an aspect of the invention may reside in a method 100 for write restricted storage. In the method, a controller 210 maintains a write authorization list 310 received over a control path 230 (step 110). The authorization list includes at least one authorized data block digest 320, and each authorized data block digest is based on a corresponding authorized data block. The controller generates a calculated digest 330 for a data block 340 received over a data path 240 (step 120). The controller determines if the calculated digest for the data block matches an authorized data block digest in the authorization list (step 130). The controller writes the data block 340 to a storage 220 if the calculated digest matches the authorized data block digest in the authorization list (step 140).

In more detailed aspects of the invention, the write controller 210 may authenticate the authorization list 310. The control path 230 may be a secure control path, and the data path 240 may not be as secure as the secure control path. Each authorized data block digest 320 may be generated from the corresponding authorized data block using a hash function.

Another aspect of the invention may reside in an apparatus 200, comprising: means (e.g., controller 210) for maintaining an authorization list 310 received over a control path 230, wherein the authorization list includes at least one authorized data block digest 320, and each authorized data block digest is based on a corresponding authorized data block; means (e.g., controller 210) for generating a calculated digest 330 for a data block 340 received over a data path 240; means (e.g. controller 210) for determining if the calculated digest for the data block matches an authorized data block digest in the authorization list; and means (e.g., controller 210) for writing the data block to a storage 220 if the calculated digest matches the authorized data block digest in the authorization list.

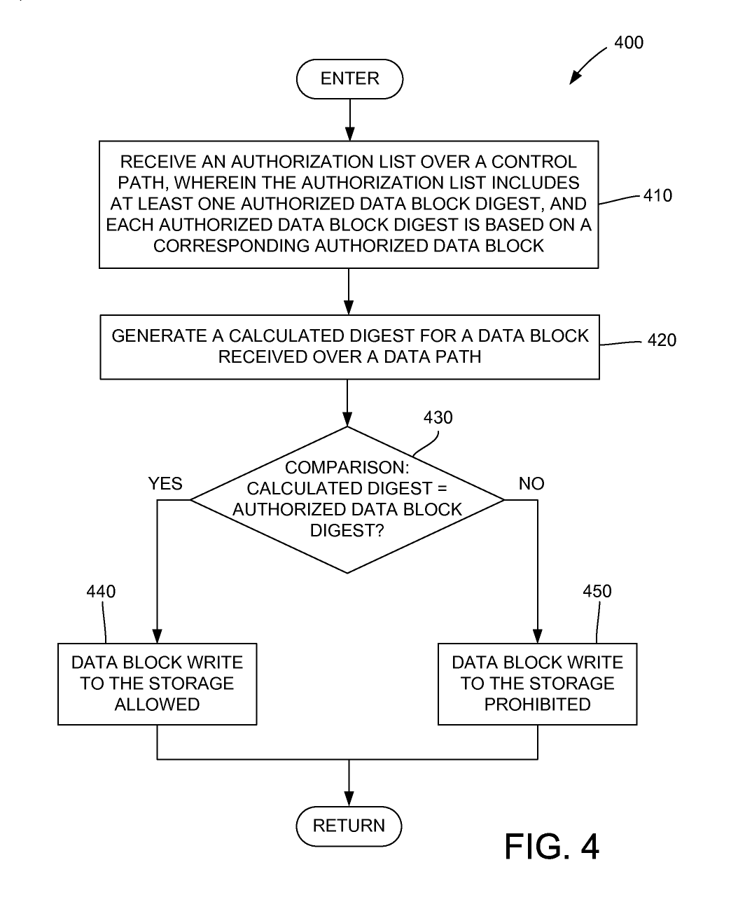

With further reference a method 400 shown in FIG. 4, another aspect of the invention may reside in an apparatus 200, comprising: a storage 220 for storing authorized data blocks received over a data path 240; and a controller 210 configured to control writes of data blocks to the storage based on an authorization list 310, received over a control path 230 (step 410), of authorized data block digests 320. Each authorized data block digest is based on a corresponding authorized data block. The controller generates a calculated digest 330 for a data block received over the data path (step 420). The controller performs a comparison of the calculated digest and the authorized data block digests to determine if calculated digest matches an authorized data block digest (step 430). The controller allows writing the data block to the storage if the calculated digest matches an authorized data block digest in the authorization list (step 440). Alternatively, the controller prohibits writing of the data block to the storage if the calculated digest does not match an authorized data block digest in the authorization list (step 450). The apparatus 200 may be an component (i.e., an integrated circuit) or an end user device (i.e., a remote station).

The apparatus 200 may comprise a computer 500 that includes a processor 510, a storage medium 520 memory and/or a disk drive, a non-volatile storage 525 such as a flash memory, a controller 530, a display 540, and an input such as a keypad 550, and a wireless connection 560.

Another aspect of the invention may reside in a computer-readable medium 520, comprising: code for causing a computer 500 to maintain an authorization list 310 received over a control path 230, wherein the authorization list includes at least one authorized data block digest 320, and each authorized data block digest is based on a corresponding authorized data block; code for causing the computer 500 to generate a calculated digest 330 for a data block 340 received over a data path; code for causing the computer 500 to determine if the calculated digest for the data block matches an authorized data block digest in the authorization list; and code for causing a computer to write the data block 340 to a storage 220 if the calculated digest matches the authorized data block digest in the authorization list.

The present invention may use an authorization list 310 to restrict the content that may be written, but may not restrict the write operation itself, or a read operation. This addresses how to protect memory/storage 220/535 from unauthorized and potentially harmful modifications while allowing, in a seamless manner, authorized changes.

The write restriction technique may provide a write method. Approved data modifications, in the form of a compact digest (hash), may be provided ahead of time. Any attempt to write data other than the pre-approved data will be rejected. Thus, only specific valid data may be written. A digest, such as a hash (PA HASH M where M is an index) may be generated for each block (e.g., each 4 KB block) of the pre-approved data. Read operations may take place without restriction.

In the context of a firmware update process, the data to be modified is known in advance, and a list 310 associated with the approved changes (data) is provided before the firmware update process begins. In the update process, no changes are needed to any components, or their operation.

The authorization list 310 should be sent from a trusted execution environment, such as a Trust Zone in the ARM architecture. Thus, the authorization list may travel over a secure control path 230 (e.g., a control bus) which is separate from the data path 240 (e.g., a data bus). The data path may not be secure. The controller 210 may verify the authenticity of the authorization list by a cryptographic mechanism such as a digital signature. The controller 210 may be a hardware device.

Unlike traditional write protection, the write restriction technique has the following qualities: (1) the write restriction is always on, and (2) the technique is transparent to users of the protection. No special action is required in order to write pre-authorized data corresponding to a authorized data block digest 320 in the authorization list 310. Thus, pre-authorized data may be written at any time and in any order, while unauthorized data may never be written. Thus, tampering or unauthorized modification of the firmware stored in the flash memory/storage 220 of a mobile computing device may be prevented, while a legitimate FOTA update may be performed without unnecessary complications.

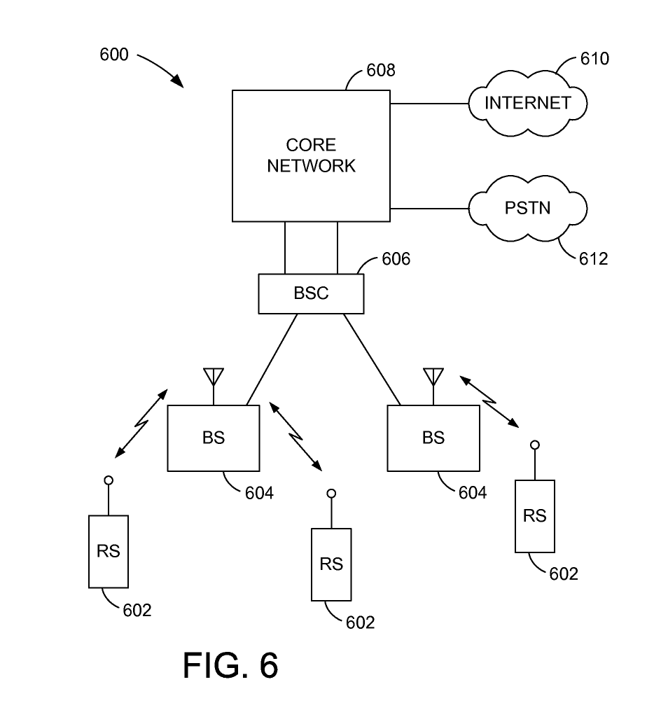

With reference to FIG. 6, a wireless remote station (RS) 602 (e.g., a mobile computing device/apparatus 200 having an integrated circuit with the controller 210) may communicate with one or more base stations (BS) 604 of a wireless communication system 600. The RS may further pair with a wireless peer device. The wireless communication system 600 may further include one or more base station controllers (BSC) 606, and a core network 608. The core network may be connected to an Internet 610 and a Public Switched Telephone Network (PSTN) 612 via suitable backhauls. A typical wireless mobile station may include a handheld phone, or a laptop computer, The wireless communication system 600 may employ any one of a number of multiple access techniques such as code division multiple access (CDMA), time division multiple access (TDMA), frequency division multiple access (TDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on as one or more instructions or code on a computer-readable medium. Computer-readable media includes computer storage media that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory such that it does not include a transitory, propagating signal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
maintaining, by a controller, an authorization list received over a control path, wherein the authorization list includes at least one authorized data block digest, and each authorized data block digest is based on a corresponding authorized data block;
generating, by the controller, a calculated digest for a data block received over a data path;
determining, by the controller, if the calculated digest for the data block matches an authorized data block digest in the authorization list; and
writing, by the controller, the data block to a storage if the calculated digest matches the authorized data block digest in the authorization list.

2. The method of claim 1, wherein the controller authenticates the authorization list.

3. The method of claim 1, wherein the control path is a secure control path.

4. The method of claim 3, wherein the data path is not as secure as the secure control path.

5. The method of claim 1, wherein each authorized data block digest is generated from the corresponding authorized data block using a hash function.

6. An apparatus, comprising:
means for maintaining an authorization list received over a control path, wherein the authorization list includes at least one authorized data block digest, and each authorized data block digest is based on a corresponding authorized data block;
means for generating a calculated digest for a data block received over a data path;
means for determining if the calculated digest for the data block matches an authorized data block digest in the authorization list; and
means for writing the data block to a storage if the calculated digest matches the authorized data block digest in the authorization list.

7. The apparatus of claim 6, further comprising means for authenticating the authorization list.

8. The apparatus of claim 6 wherein the control path is a secure control path.

9. The apparatus of claim 8, wherein the data path is not as secure as the secure control path.

10. The apparatus of claim 6, wherein each authorized data block digest is generated from the corresponding authorized data block using a hash function.

11. An apparatus, comprising:
a storage for storing authorized data blocks received over a data path; and
a controller configured to control writes of data blocks to the storage based on an authorization list, received over a control path, of authorized data block digests, wherein
each authorized data block digest is based on a corresponding authorized data block;
the controller further configured to:
generate a calculated digest for a data block received over the data path;
allow writing the data block to the storage if the calculated digest matches an authorized data block digest in the authorization list; and
prohibit writing of the data block to the storage if the calculated digest does not match an authorized data block digest in the authorization list.

12. The apparatus of claim 11, wherein the controller authenticates the authorization list.

13. The apparatus of claim 11, wherein the control path is a secure control path.

14. The apparatus of claim 13, wherein the data path is not as secure as the secure control path.

15. The apparatus of claim 11, wherein each authorized data block digest comprises 256 bits, and each authorized data block comprises at least 4 kilobytes.

16. A computer-readable medium, comprising:
code for causing a computer to maintain an authorization list received over a control path, wherein the authorization list includes at least one authorized data block digest, and each authorized data block digest is based on a corresponding authorized data block;
code for causing the computer to generate a calculated digest for a data block received over a data path;
code for causing the computer to determine if the calculated digest for the data block matches an authorized data block digest in the authorization list; and
code for causing a computer to write the data block to a storage if the calculated digest matches the authorized data block digest in the authorization list.

17. The computer-readable medium of claim 16, further comprising code for causing the computer to authenticate the authorization list.

18. The computer-readable medium of claim 16, wherein the control path is a secure control path.

19. The computer-readable medium of claim 18, wherein the data path is not as secure as the secure control path.

20. The computer-readable medium of claim 16, wherein each authorized data block digest is generated from the corresponding authorized data block using a hash function.
